(19) United States
(12) Patent Application Publication
(10) Pub. No.: US 2017/0344709 A1
(43) Pub. Date: Nov. 30, 2017

(54) MEDICAL PATIENT BILLING SESSION USING A TEMPORARY IDENTITY

(71) Applicant: International Business Machines Corporation, Armonk, NY (US)

(72) Inventor: Kuntal Dey, West Bengal (IN)

(21) Appl. No.: 15/166,999

(22) Filed: May 27, 2016

(51) Int. Cl. G06F 19/00

(52) U.S. Cl. CPC G06F 19/328; G06F 19/321; G06F 19/322

(57) ABSTRACT

One embodiment provides a method including: utilizing at least one processor to execute computer code that performs the steps of: obtaining biometric information from a plurality of patients, wherein the biometric information comprises an image of each of the plurality of patients; obtaining at least one medical document associated with each of the plurality of patients; assigning a temporary identity to each of the plurality of patients; creating a billing session for each of the temporary identities, wherein the billing session comprises at least a subset of the medical document and the biometric information for the respective patient; storing, in a database, the billing sessions and a timestamp for each of the billing sessions; obtaining new biometric information from a particular patient, wherein the new biometric information comprises an image of the particular patient; identifying the temporary identity assigned to the particular patient by identifying, from the database, the temporary identity having biometric information that matches the new biometric information; and retrieving, from the database, the billing session of the particular patient. Other aspects are described and claimed.

### BACKGROUND

When a patient visits a medical office, often the most consuming part for the patient is waiting. The patient has to wait for the physician or technician to perform an examination or tests, and the patient also has to wait for paperwork to be updated so that a bill for the services can be generated. Additionally, the patient may have to wait until the billing department can contact the insurance company to determine whether the tests, examinations, or other services are covered by the insurance company. If the patient is already a patient of the office, the wait times may be reduced because the patient's information (e.g., insurance information, reason for visiting the office, medical history, etc.) is already in the system. Additionally, because the patient is already a patient of the office, the office may be willing to bill the patient at a later time, which allows the patient to leave the office sooner.

However, if the patient is receiving outpatient services, the patient is generally not admitted to the office or hospital performing the services. In such cases, before the patient can be seen by the physician or technician performing the services, the patient has to wait until the hospital or office staff enters all the information for the patient into the system. For example, the staff has to obtain the paperwork describing the tests or procedures to be performed from the patient and enter this information into the system. Additionally, the staff has to determine whether the patient's insurance will cover the tests to be performed. Many times the patient cannot even receive the services until either the patient has paid for the services or the office staff has determined that an insurance company will cover the services.

### BRIEF SUMMARY

In summary, one aspect of the invention provides a method, comprising: utilizing at least one processor to execute computer code that performs the steps of: obtaining biometric information from a plurality of patients, wherein the biometric information comprises an image of each of the plurality of patients; obtaining at least one medical document associated with each of the plurality of patients; assigning a temporary identity to each of the plurality of patients; creating a billing session for each of the temporary identities, wherein the billing session comprises at least a subset of the medical document and the biometric information for the respective patient; storing, in a database, the billing sessions and a timestamp for each of the billing sessions; obtaining new biometric information from a particular patient, wherein the new biometric information comprises an image of the particular patient; identifying the temporary identity assigned to the particular patient by identifying, from the database, the temporary identity having biometric information that matches the new biometric information; and retrieving, from the database, the billing session of the particular patient.

Another aspect of the invention provides an apparatus, comprising: at least one processor; and a computer readable storage medium having computer readable program code embodied therewith and executable by the at least one processor, the computer readable program code comprising: computer readable program code that obtains biometric information from a plurality of patients, wherein the biometric information comprises an image of each of the plurality of patients; computer readable program code that obtains at least one medical document associated with each of the plurality of patients; computer readable program code that assigns a temporary identity to each of the plurality of patients; computer readable program code that creates a billing session for each of the temporary identities, wherein the billing session comprises at least a subset of the medical document and the biometric information for the respective patient; computer readable program code that stores, in a database, the billing sessions and a timestamp for each of the billing sessions; computer readable program code that obtains new biometric information from a particular patient, wherein the new biometric information comprises an image of the particular patient; computer readable program code that identifies the temporary identity assigned to the particular patient by identifying, from the database, the temporary identity having biometric information that matches the new biometric information; and computer readable program code that retrieves, from the database, the billing session of the particular patient.

An additional aspect of the invention provides a computer program product, comprising: a computer readable storage medium having computer readable program code embodied therewith, the computer readable program code comprising: computer readable program code that obtains biometric information from a plurality of patients, wherein the biometric information comprises an image of each of the plurality of patients; computer readable program code that obtains at least one medical document associated with each of the plurality of patients; computer readable program code that assigns a temporary identity to each of the plurality of patients; computer readable program code that creates a billing session for each of the temporary identities, wherein the billing session comprises at least a subset of the medical document and the biometric information for the respective patient; computer readable program code that stores, in a database, the billing sessions and a timestamp for each of the billing sessions; computer readable program code that obtains new biometric information from a particular patient, wherein the new biometric information comprises an image of the particular patient; computer readable program code that identifies the temporary identity assigned to the particular patient by identifying, from the database, the temporary identity having biometric information that matches the new biometric information; and computer readable program code that retrieves, from the database, the billing session of the particular patient.

A further aspect of the invention provides a method, comprising: initiating a billing session comprising creating a temporary identity for a patient after obtaining biometric information comprising an image of the patient and at least one medical document associated with the patient; generating a list of events contained within the at least one medical document by analyzing the at least one medical document using a semantic analysis technique; associating the biometric information of the patient, the at least one medical document, and the list of events to the billing session; storing the billing session in a database; and retrieving the billing session after obtaining new biometric information comprising an image of the patient and matching the new biometric information of the patient to biometric information contained within the database.

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 illustrates a method of generating a medical patient billing session using a temporary identity.

FIG. 2 illustrates an architecture of a medical patient billing session using a temporary identity.

FIG. 3 illustrates an example medical document.

FIG. 4 illustrates a computer system.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in at least one embodiment. In the following description, numerous specific details are provided to give a thorough understanding of embodiments of the invention. One skilled in the relevant art may well recognize, however, that embodiments of the invention can be practiced without at least one of the specific details thereof, or can be practiced with other methods, components, materials, et cetera. In other instances, well-known structures, materials, or operations are not shown or described in detail to avoid obscuring aspects of the invention.

The illustrated embodiments of the invention will be best understood by reference to the figures. The following description is intended only by way of example and simply illustrates certain selected exemplary embodiments of the invention as claimed herein. It should be noted that the flowchart and block diagrams in the figures illustrate the architecture, functionality, and operation of possible implementations of systems, apparatuses, methods and computer program products according to various embodiments of the invention. In this regard, each block in the flowchart or block diagrams may represent a module, segment, or portion of code, which comprises at least one executable instruction for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

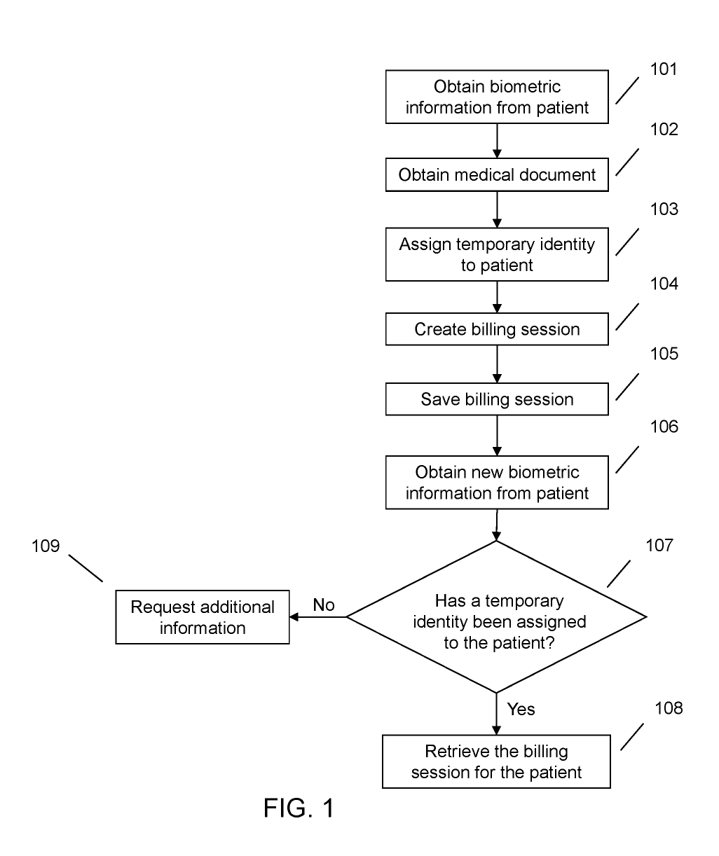

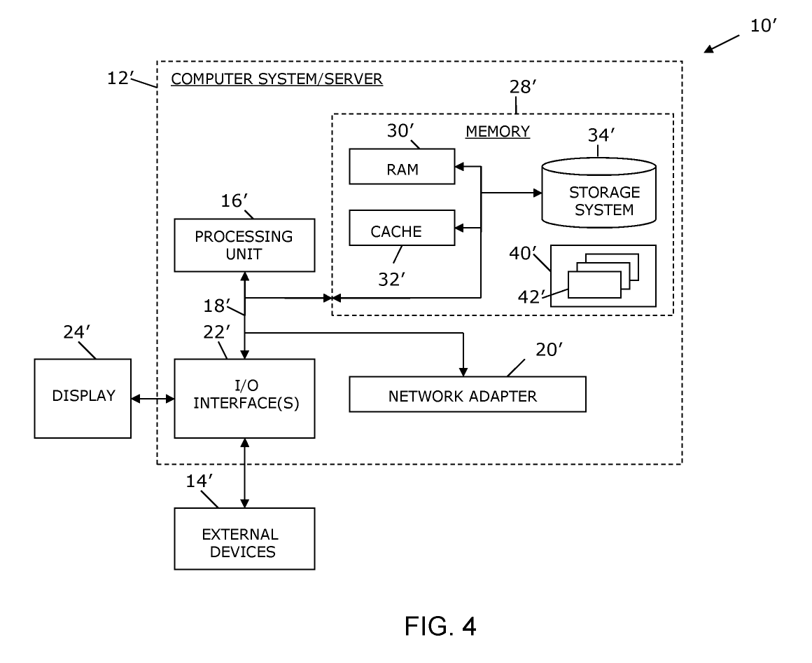

Specific reference will be made here below to FIGS. 1-3. It should be appreciated that the processes, arrangements and products broadly illustrated therein can be carried out on, or in accordance with, essentially any suitable computer system or set of computer systems, which may, by way of an illustrative and non-restrictive example, include a system or server such as that indicated at 12′ in FIG. 4. In accordance with an example embodiment, most if not all of the process steps, components and outputs discussed with respect to FIGS. 1-3 can be performed or utilized by way of a processing unit or units and system memory such as those indicated, respectively, at 16′ and 28′ in FIG. 4, whether on a server computer, a client computer, a node computer in a distributed network, or any combination thereof.

For a patient wanting to receive hospital or physician services, waiting for office staff to update paperwork and information for a patient can be time consuming and frustrating. Sometimes the patient is not even put on the waiting list until the office staff can determine how the services will be paid for. Generally, the patient receiving process works such that the patient has to go to the receiving desk and provide the paperwork describing the tests and possibly a brief medical history to the office staff. The staff then manually enters both the personal information for the patient and the information provided on the medical forms that the patient has provided. The office staff may then determine whether the patient has insurance and whether insurance will cover the services to be rendered. If the insurance will not cover the services, then the patient may have to pay for the services before the hospital or office will render the services. Such a system results in a time-consuming and frustrating process for a patient just needing to have some tests performed.

Accordingly, an embodiment provides a method of creating a billing session for a medical patient using a temporary identity. An embodiment may obtain biometric information (e.g., image, fingerprint, retina, palm print, DNA, etc.) from a patient. An embodiment may also obtain at least one medical document (e.g., prescription, medical history, doctor notes, etc.) from or associated with the patient. For example, a patient may access a check-in counter in a hospital or medical office. At the check-in counter images may be taken of the patient and the medical documents for the patient. In one embodiment, the medical documents may be analyzed to create a list of events contained within the documents. For example, an embodiment may identify the dates of the events and sort the events to create an event list.

An embodiment may then assign a temporary identity to the patient and create a billing session for the patient. The billing session may include the images of the patient and at least a subset of the medical documents that the patient provided. The billing session may then be stored in a database. When a patient then accesses the billing station, for example, the location where the office staff is located, an embodiment may obtain biometric information of the patient. Using this new biometric information, an embodiment may search the database to find the temporary identity that has been assigned to the patient. An embodiment may then retrieve the billing session which contains the medical documents for the patient. The office staff can then interact with the billing session to provide the bill to the patient. Once the bill has been generated or provided to the patient, an embodiment may delete the temporary identity and information stored with the temporary identity.

Such a system provides a technical improvement over current system for billing a medical patient when they wish to receive medical treatment. The systems as described herein provide a billing system that allows a patient to provide information to the hospital or office. The systems and methods described herein prevent the office staff from having to manually input the information and access databases to determine whether the patient is a returning patient and what information needs to be added to the patient's file. Rather, the system automatically generates a temporary identity for the patient and analyzes the medical documents provided by the patient to create a billing session for the patient. Thus, the billing for the patient may be completed quicker and more efficiently than using standard manual methods. Therefore, the time that a patient spends waiting for the billing process to be completed is greatly reduced allowing the patient to receive the requested medical services quicker and leave the hospital or office faster.

For ease of understanding, the example of a medical office and medical services is used herein. However, it should be understood that the systems and methods as described herein can be applied to other systems which have billing systems.

Referring now to FIG. 1, at 101, an embodiment may obtain biometric information from a patient. The biometric information may include an image of the patient, a fingerprint of the patient, a retinal scan, a DNA sample, palm print, and the like. In obtaining the biometric information, sensors (e.g., camera, fingerprint scanner, retinal scanner, etc.) may be employed. For example, a camera may take an image of the patient, a fingerprint scanner may obtain a fingerprint from the patient, and the like.

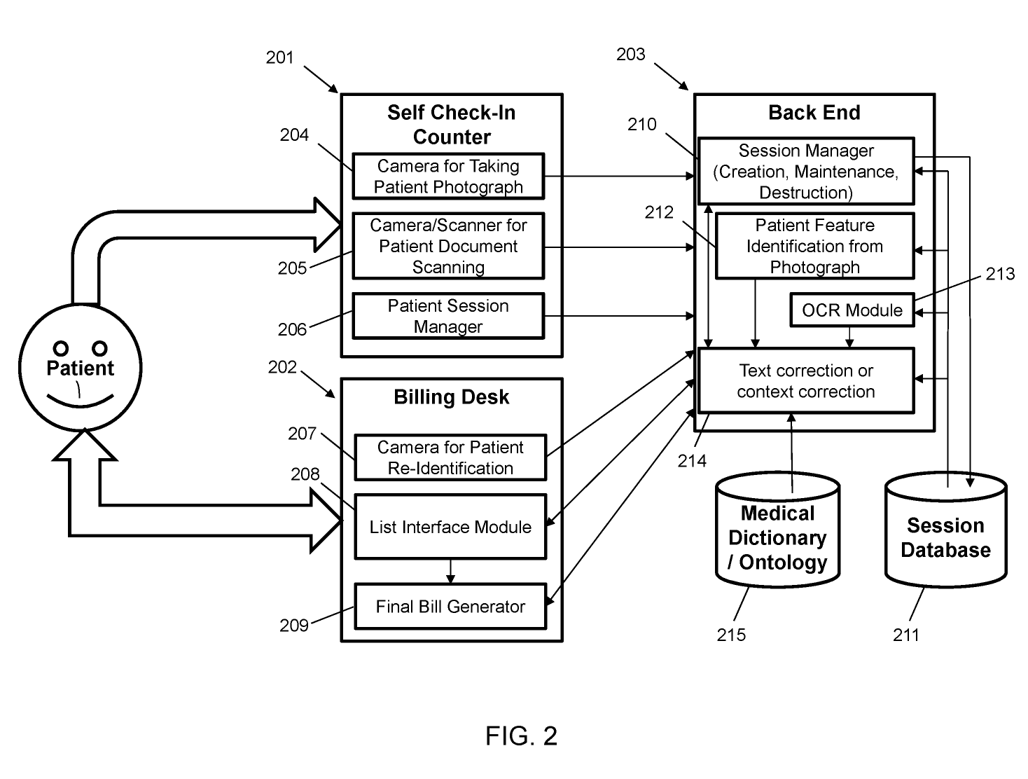

As an example, referring to FIG. 2, a patient may access a self-service check-in counter or kiosk 201 at a medical office. The self-service counter or kiosk may also be at a location different from the medical office. For example, the patient may check-in from an information handling device (e.g., laptop, smart phone, personal computer, tablet, smart watch, etc.) at home and then go to the medical office. The patient may select a button or prompt to start the check-in session. For example, the patient may select a “Get Started” button on a display screen, may press a start button located on the counter or kiosk 201, and the like. The kiosk 201 may include a camera 204 for taking a patient photograph take a picture of the patient. For example, the patient may be prompted to stand at a certain location so that a picture of the patient's face can be taken. Once the image or biometric information is taken, the system may perform an analysis of the image or biometric information. For example, the system may extract facial features 212, fingerprint features, and the like. The analysis may be performed not to specifically identify the patient, but rather may be used to extract features to be compared with at a later point in time. In other words, the system may extract unique features that can be used as a comparison for later comparison or identification.

At 102, an embodiment may obtain at least one medical document from or associated with the patient. For example, an embodiment may scan the medical document, take a picture of the document, scan a barcode corresponding to a link to a file containing the document, and the like. Referring back to FIG. 2, the counter 201 may include a camera or scanner 205 for obtaining the medical documents. In the case of a camera, the camera used for taking the patient photograph and the camera for obtaining the medical documents may be the same or a different camera. The medical document may include a prescription from a doctor, a note from a physician, a medical history form, a list of the requested services and tests to be performed, and the like.

In one embodiment, the obtained medical documents may be analyzed to extract information. It should be noted that the document analysis may be performed at a different time, for example, after the temporary identity or billing session has been created at 103 or 104. The medical documents may be analyzed to generate a list of events. In one embodiment, the document analysis may include identifying a chronology of events, for example, by identifying dates included in the medical documents. An embodiment may then sort the events in chronological order, for example, in ascending or descending chronological order.

In one embodiment text analysis (e.g., text recognition, optical character recognition 213, handwriting analysis, word recognition, semantic analysis, etc.) may be performed on the medical documents. Such techniques may allow an embodiment to identify words and characters contained within the medical documents, including when the documents contain handwriting. The text analysis may also include identifying words or characters included in the medical documents which the system has identified as having a low confidence of recognition. In other words, the system may identify words, characters, numbers, graphics, and the like, which the system could not recognize or distinguish or the characters that were identified by the system as having a low confidence of correctness.

In this case, the system may use a text correction technique 214 to correct or recognize the text. The text correction or context correction 214 may also be used if the system identifies more than one option for the recognized text. For example, if the system has identified an abbreviation within the medical documents that could stand for more than one word, the system may use the text or context correction to identify the correct version of the word. One text correction technique may include using a context recognition technique to identify the words or characters by using the identified words or characters surrounding the unknown word. For example, the system may identify words based upon the premise that the documents are medical documents. Therefore, the system may access a medical dictionary or ontology 215 to identify the missing terms.

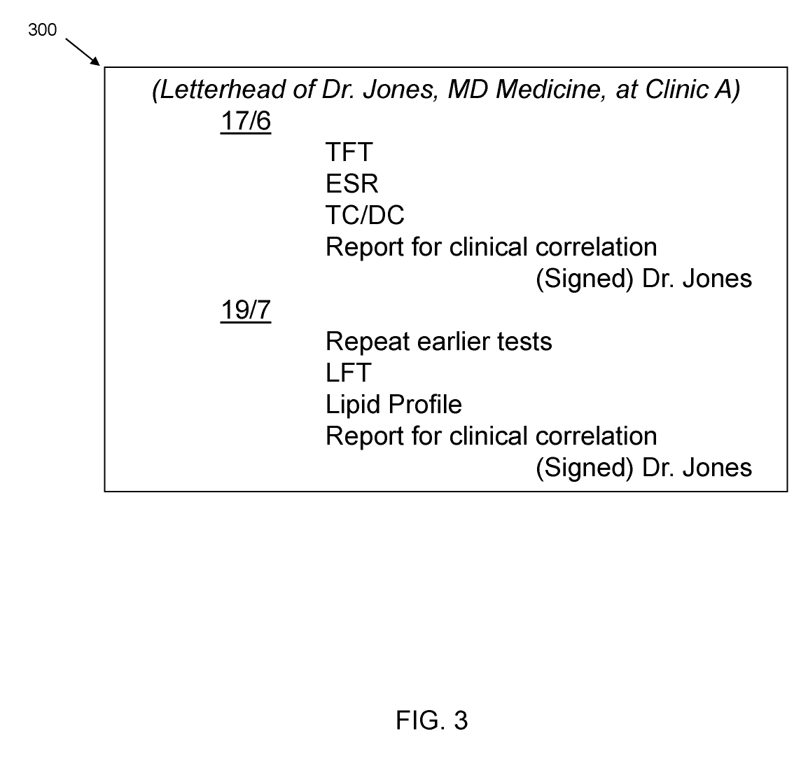

As an example, referring to FIG. 3, assume that the medical document 300 includes a handwritten note on doctor letterhead. The document includes two dates (i.e., 17/6 and 19/7) of events. Under each date is a list of notes. Assume the system has identified all the terms except “LFT” under the 19/7 date and “LFT” was not clearly written. The system may identify three possibilities, “TFT,” “LFT,” and “LET.” Since the system has already identified the term “Lipid Profile,” using a medical dictionary or ontology the system may identify that the terms “TFT” and “LFT” generally co-occur with the term “Lipid Profile.” Thus, the system may associate “TFT” and “LFT” with a higher confidence or probability of being correct. Conversely, the system may associate “LET” as having a low probability of being correct. The system has also identified that the phrase “Repeat earlier tests” is associated with the date 19/7. The system has already identified that the term “TFT” is included in the earlier tests. Thus, “TFT” becomes associated with the 19/7 date as a derived item on the list, because that test is supposed to be repeated. Therefore, the system may presume that the term “TFT” would not be included again under the 19/7 date. Thus, the system may associate the term “LFT” as having a high probability of being included under the 19/7 date and may, therefore, include it under the 19/7 date.

At 103, an embodiment may assign a temporary identity to the patient using a patient session manager 206. The temporary identity may include a unique number identifier for the patient, a unique name which may not be the patient's actual name, a unique placeholder in a database, a link to a particular storage location, queue sequence number, token identification, or some other way to uniquely identify the patient and session for the patient. The temporary identity may also include generating and providing the patient with a ticket or receipt having a machine-readable optical label (e.g., barcode, quick response code, etc.) associated with the temporary identity created for the patient. The assignment of a temporary identity may occur before, after, or in conjunction with the creation of the billing session at 104.

An embodiment may create a billing session at 104, using a session manager 210 for the temporary identity, and in turn, the patient. The previously obtained biometric information, at least a subset of the medical documents, and the temporary identity may then be associated with the billing session. The subset of the medical documents may include the list generated through the document analysis. A subset of the medical documents may also include just a partial set of the information included in the medical document. For example, the system may only include the information under the latest date because these are the only tests that the patient will be receiving at this time. The system may also generate lists of possible tests or appointments that the patient could be billed for at this time. Using the example of FIG. 3, the system may generate a list of possible tests that the patient may be having. Each of the tests may also have a confidence score associated with it which may indicate how probable it is that the patient is going to have that test performed. Another list that may be generated is a list of possible appointments (i.e., “Report for clinical correlation”). Thus, the system may create lists including possible services (e.g., tests, appointments, etc.) that the patient may be receiving.

One embodiment may attempt to correctly identify the patient. An embodiment may complete this by mapping the temporary identities to actual identities using either the biometric information or medical documents obtained previously. For example, the system may have access to a database having actual patient identities including biometric information. The system may search the database and find the actual identity matching the biometric information and then associate the temporary identity to the actual identity of the patient. Alternatively or additionally, the system may use information (e.g., name, birthdate, identification number, doctor name, date of visit, etc.) identified from the medical documents to identify the patient. For example, an embodiment may identify that the patient visited a particular doctor on a particular date for a particular condition. The system may then access the doctor's files or schedule to determine which patient visited the doctor on that date for that condition. If the actual identity of the patient can be identified, the system may use this information to initiate an insurance search (e.g., determine if the test would be covered, determine if the patient has insurance, etc.), fill in missing or unknown information, and the like.

At 105, the billing session may be stored in a session database 211. In addition, the billing session may be marked with a timestamp which may indicate the time the patient initiated the session, when the session was last accessed, when the session was finished, and the like. As is understood, the process of obtaining biometric information from a patient, obtaining medical documents from the patient, assigning a temporary identity to the patient, creating a billing session, and saving a billing session can be completed for multiple patients. In other words, the database can store information for many different patients all having temporary identities, or actual identities if the temporary identities are mapped to the actual identities.

At 106, an embodiment may receive new biometric information from a patient. The biometric information may be the same type of biometric information and obtained in a similar manner as discussed in conjunction with step 101. However, at this step, the patient may be accessing a second location or counter, for example, a billing desk 202. In other words, once the system has processed and saved multiple possible lists with the temporary identity, a patient may go to the billing desk 202 to pay for or select the services that the patient wishes to complete. The billing desk 202 may be run by a human operator.

At this point, the patient may provide the receipt that he or she received, if applicable. Using the biometric information received at 106 and/or the provided receipt, an embodiment may determine whether the patient has been assigned a temporary identity. An embodiment may make this determination by comparing the new biometric information received at 106 to the biometric information contained within the session database 211. For example, the facial features extracted from an image received at 106 may be compared to facial features of images previously stored in the session database 211. If the database 211 does not include a temporary identity matching the biometric information or receipt, an embodiment may request additional information at 109. For example, an embodiment may request the patient provide a name, birthdate, prescription, and the like. Alternatively, an embodiment may prompt the patient to return to the check-in counter 201 to start the check-in process.

If, however, the new biometric information received at 106 does match biometric information for a temporary identity in the session database 211 at 107, an embodiment may retrieve the billing session that was created for the patient at 108. The operator of the billing desk 202 may be presented with a list interface module 208. The list interface module 208 may include the lists previously created by the system. Using the example explained in conjunction with FIG. 4, the list interface module may provide the operator with the list of possible tests and the list including the possible appointment. The operator may interact with the lists. For example, the operator may correct any mistakes made in analyzing the medical documents, removing unnecessary information, adding additional information, and the like. The operator may also select the tests or services that the patient wants to complete at this time. For example, if the patient wants to complete the LFT test that was noted on the medical documents, the operator may select this test for billing. The system may then use a final bill generator 209 to auto-generate a bill or multiple bills for the patient including the selected services.

In one embodiment, the system may auto-generate a plurality of bills, each bill having different tests or services included with them. For example, the system may generate a bill for the list containing the tests and another bill for the list containing the appointment for the patient. The operator may then select the correct bill for printing or presenting to the patient as opposed to selecting the correct services. The plurality of bills can be broken up by list, single services (e.g., one bill for each test, one bill for each appointment, etc.), a grouping of related services (e.g., one bill for the tests that are normally performed together, etc.) and the like. In generating multiple bills, an embodiment may associate each bill with a probability. For example, the system may identify a bill containing the services that are most likely to be performed as having a high probability of being selected. The bills may then be presented in an order based upon the probability, for example, the bill having the highest probability first, at the top of the list, in the foremost window, and the like. The operator may also edit the auto-generated bills. For example, if the bill having the highest probability is correct except the patient decides not to complete one of the services, the operator may delete that service from the bill, rather than finding the bill having the exactly correct services.

In one embodiment, once the operator has selected the test(s) or service(s) to bill the patient for, the system may submit an insurance claim, if the temporary identity was mapped to an actual identity and the patient has insurance. The system may also allow the operator to enter insurance information into the system. For example, if the patient has insurance but that information is not included in the database, the patient or operator may now provide that information to the system. Once the bill has been generated, the billing session may be deleted or otherwise marked for destruction. Such deletion may include discarding the temporary identity, medical documents, analysis documents, and the like. The deletion may also include copying the actual tests performed to another system under the actual patient's identity and then deleting all documents and information associated with the temporary identity.

The billing session may also be discarded after a predetermined period of inactivity. For example, if the timestamp associated with the billing session exceeds a predetermined threshold (e.g., days, hours, weeks, minutes, particular date, etc.), which may be a default value or user-defined value, the billing session may be discarded from the system. The discarding of billing sessions for session time-outs may also occur at regular intervals and all billing sessions having a date past a predetermined date may be discarded. For example, the system may run a time-out cleaning on the 15^{th} of every month where every billing session having a date on or before the 15^{th} of the previous month is discarded.

As shown in FIG. 4, computer system/server 12′ in computing node 10′ is shown in the form of a general-purpose computing device. The components of computer system/server 12′ may include, but are not limited to, at least one processor or processing unit 16′, a system memory 28′, and a bus 18′ that couples various system components including system memory 28′ to processor 16′. Bus 18′ represents at least one of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12′ typically includes a variety of computer system readable media. Such media may be any available media that are accessible by computer system/server 12′, and include both volatile and non-volatile media, removable and non-removable media.

System memory 28′ can include computer system readable media in the form of volatile memory, such as random access memory (RAM) 30′ and/or cache memory 32′. Computer system/server 12′ may further include other removable/non-removable, volatile/non-volatile computer system storage media. By way of example only, storage system 34′ can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18′ by at least one data media interface. As will be further depicted and described below, memory 28′ may include at least one program product having a set (e.g., at least one) of program modules that are configured to carry out the functions of embodiments of the invention.

Program/utility 40′, having a set (at least one) of program modules 42′, may be stored in memory 28′ (by way of example, and not limitation), as well as an operating system, at least one application program, other program modules, and program data. Each of the operating systems, at least one application program, other program modules, and program data or some combination thereof, may include an implementation of a networking environment. Program modules 42′ generally carry out the functions and/or methodologies of embodiments of the invention as described herein.

Computer system/server 12′ may also communicate with at least one external device 14′ such as a keyboard, a pointing device, a display 24′, etc.; at least one device that enables a user to interact with computer system/server 12′; and/or any devices (e.g., network card, modem, etc.) that enable computer system/server 12′ to communicate with at least one other computing device. Such communication can occur via I/O interfaces 22′. Still yet, computer system/server 12′ can communicate with at least one network such as a local area network (LAN), a general wide area network (WAN), and/or a public network (e.g., the Internet) via network adapter 20′. As depicted, network adapter 20′ communicates with the other components of computer system/server 12′ via bus 18′. It should be understood that although not shown, other hardware and/or software components could be used in conjunction with computer system/server 12′. Examples include, but are not limited to: microcode, device drivers, redundant processing units, external disk drive arrays, RAID systems, tape drives, and data archival storage systems, etc.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method, comprising:
utilizing at least one processor to execute computer code that performs the steps of:
obtaining biometric information from a plurality of patients, wherein the biometric information comprises an image of each of the plurality of patients;
obtaining at least one medical document associated with each of the plurality of patients;
assigning a temporary identity to each of the plurality of patients;
creating a billing session for each of the temporary identities, wherein the billing session comprises at least a subset of the medical document and the biometric information for the respective patient;
storing, in a database, the billing sessions and a timestamp for each of the billing sessions;
obtaining new biometric information from a particular patient, wherein the new biometric information comprises an image of the particular patient;
identifying the temporary identity assigned to the particular patient by identifying, from the database, the temporary identity having biometric information that matches the new biometric information; and
retrieving, from the database, the billing session of the particular patient.

2. The method of claim 1, comprising analyzing, for each of the plurality of patients, the at least one medical document to generate a list of events included within the at least one medical document, using a semantic analysis technique.

3. The method of claim 2, wherein the analyzing comprises recognizing text included within the at least one medical document using a text recognition technique.

4. The method of claim 3, wherein the analyzing comprises correcting recognized text using a context recognition technique to identify text having a confidence level associated with the text recognition below a threshold.

5. The method of claim 2, wherein the analyzing comprises identifying dates of events included within the at least one medical document.

6. The method of claim 5, wherein the analyzing comprises sorting the events in chronological order.

7. The method of claim 1, comprising identifying at least one of the plurality of patients by comparing the biometric information to a database comprising known patients and associating the temporary identity with the known patient having matching biometric information.

8. The method of claim 1, comprising generating a bill for the particular patient based upon the billing session and deleting the temporary identity corresponding to the particular patient and at least one medical document corresponding to the particular patient after generating the bill.

9. The method of claim 1, comprising discarding a billing session having a timestamp exceeding a predetermined threshold.

10. The method of claim 1, wherein the obtaining biometric information comprises obtaining biometric information in addition to the image of the plurality of patients.

11. The method of claim 1, wherein the creating a billing session comprises generating a ticket having a machine-readable optical label and providing the ticket to the patient.

12. An apparatus, comprising:
at least one processor; and
a computer readable storage medium having computer readable program code embodied therewith and executable by the at least one processor, the computer readable program code comprising:
computer readable program code that obtains biometric information from a plurality of patients, wherein the biometric information comprises an image of each of the plurality of patients;
computer readable program code that obtains at least one medical document associated with each of the plurality of patients;
computer readable program code that assigns a temporary identity to each of the plurality of patients;
computer readable program code that creates a billing session for each of the temporary identities, wherein the billing session comprises at least a subset of the medical document and the biometric information for the respective patient;
computer readable program code that stores, in a database, the billing sessions and a timestamp for each of the billing sessions;
computer readable program code that obtains new biometric information from a particular patient, wherein the new biometric information comprises an image of the particular patient;
computer readable program code that identifies the temporary identity assigned to the particular patient by identifying, from the database, the temporary identity having biometric information that matches the new biometric information; and
computer readable program code that retrieves, from the database, the billing session of the particular patient.

13. A computer program product, comprising:
a computer readable storage medium having computer readable program code embodied therewith, the computer readable program code comprising:
computer readable program code that obtains biometric information from a plurality of patients, wherein the biometric information comprises an image of each of the plurality of patients;
computer readable program code that obtains at least one medical document associated with each of the plurality of patients;
computer readable program code that assigns a temporary identity to each of the plurality of patients;
computer readable program code that creates a billing session for each of the temporary identities, wherein the billing session comprises at least a subset of the medical document and the biometric information for the respective patient;
computer readable program code that stores, in a database, the billing sessions and a timestamp for each of the billing sessions;
computer readable program code that obtains new biometric information from a particular patient, wherein the new biometric information comprises an image of the particular patient;
computer readable program code that identifies the temporary identity assigned to the particular patient by identifying, from the database, the temporary identity having biometric information that matches the new biometric information; and
computer readable program code that retrieves, from the database, the billing session of the particular patient.

14. The computer program product of claim 13, comprising code that analyzes, for each of the plurality of patients, the at least one medical document to generate a list of events included within the at least one medical document, using a semantic analysis technique.

15. The computer program product of claim 14, wherein the analyzing comprises recognizing text included within the at least one medical document using a text recognition technique.

16. The computer program product of claim 15, wherein the analyzing comprises correcting recognized text using a context recognition technique to identify text having a confidence level associated with the text recognition below a threshold.

17. The computer program product of claim 14, wherein the analyzing comprises identifying dates of events included within the at least one medical document and sorting the events in chronological order.

18. The computer program product of claim 13, comprising code that identifies at least one of the plurality of patients by comparing the biometric information to a database comprising known patients and associating the temporary identity with the known patient having matching biometric information.

19. The computer program product of claim 13, comprising code that generates a bill for the particular patient based upon the billing session and deleting the temporary identity corresponding to the particular patient and at least one medical document corresponding to the particular patient after generating the bill.

20. A method, comprising:
initiating a billing session comprising creating a temporary identity for a patient after obtaining biometric information comprising an image of the patient and at least one medical document associated with the patient;
generating a list of events contained within the at least one medical document by analyzing the at least one medical document using a semantic analysis technique;
associating the biometric information of the patient, the at least one medical document, and the list of events to the billing session;
storing the billing session in a database; and
retrieving the billing session after obtaining new biometric information comprising an image of the patient and matching the new biometric information of the patient to biometric information contained within the database.
